(19) United States
(12) Patent Application Publication
(10) Pub. No.: US 2026/0196767 A1
(43) Pub. Date: Jul. 9, 2026

(54) HIGH VOLTAGE INSULATED BREAKAWAY CONNECTOR AND METHODS OF USE

(71) Applicant: James Moreda, Soulsbyville, CA (US)

(72) Inventor: James Moreda, Soulsbyville, CA (US)

(21) Appl. No.: 19/444,173

(22) Filed: Jan. 8, 2026

Related U.S. Application Data
(60) Provisional application No. 63/743,189, filed on Jan. 8, 2025.

(51) Int. Cl. H01R 13/623

(52) U.S. Cl. CPC H01R 13/623

(57) ABSTRACT

A breakaway connector integrated into service drop lines to ensure safer and more reliable electricity transmission. This innovative connector is particularly configured to secure both overhead high and low-voltage service drop power lines, efficiently transmitting electricity while protecting utility and end-user assets from damage. The breakaway connector may include a male connector half and a female connector half, each incorporating multiple conductive cables and designed to maintain robust and secure electrical continuity. The connector features a unique design with helical channels, receivers, and fasteners, which include a predetermined failure point to shear under specific conditions, preventing infrastructure damage. Further, the connector is equipped with insulated regions, alignment features, and varied sizes of receptacles and contacts to prevent misalignment and ensure proper connection. The breakaway connector provides a reliable method for linemen to replace and reconnect supply drop powerline connectors in the event of downed lines.

### FIELD OF THE INVENTION

The present invention relates generally to the field of electrical utility infrastructure, specifically to connectors used within service drop lines for electricity transmission. The invention relates to a breakaway connector designed to enhance the safety and reliability of power delivery from utility infrastructure to various end-user structures, such as residential homes or commercial buildings, by mitigating potential damage during overload or accidental disconnection scenarios.

### BACKGROUND OF THE INVENTION

Breakaway connectors are commonly applied within overhead power line systems. During specific instances, breakaway connectors may decouple or disconnect from the main power line, minimizing the damage to the surrounding environment. These conditions may include extreme weather or traffic accidents where excessive force is applied to the overhead power line.

One key application for breakaway connectors is at the service drop line, where power is distributed to the utility customer's residence, whether that be a commercial building or residential property. The overhead power lines from the utility company drop vertically to create a service drop. Service drops may include at least three cables or conductors, where two cables are designated as “hot” wires and one cable is the neutral conductor. Once the service drop reaches the location of service, the cables are connected to a service head, which connects directly to the service panel or breaker box of the service area.

There may be more types of service drop cables utilized by the utility company, including but not limited to, duplex, triplex, and quadruplex cables. Triplex cables may include a single conductor, one neutral wire, and a ground wire, whereas quadruplex cables include two conductors, one neutral wire, and a single ground wire.

Supply drop connectors are critical components in electrical power distribution systems, particularly for the final leg of power delivery from main distribution lines to individual utility recipients, such as residential homes, commercial buildings, or industrial facilities. Conventional supply drop connectors, however, have several shortcomings that limit their effectiveness and reliability, especially in adverse conditions.

One significant limitation of existing supply drop connectors is their vulnerability to physical disruptions, such as falling trees, severe weather conditions, or accidental impacts. When such incidents occur, the supply drop connectors often suffer irreparable damage, leading to a complete disconnection of the utility recipient from the power grid. This not only results in power outages but also necessitates extensive repair efforts, often involving complete replacement of the connector and associated wiring.

Furthermore, the traditional supply drop connectors are not designed for easy reattachment or resecuring after being disconnected or damaged. As a result, utility companies face increased labor and material costs, alongside longer restoration times, which is inconvenient for both the utility providers and the recipients. The complexity of the repair process typically requires skilled technicians and specialized equipment, further contributing to the delay and expense.

Another drawback of current designs is the lack of flexibility and adaptability in various environmental conditions. Most existing connectors do not offer sufficient resistance to environmental stressors such as moisture, temperature fluctuations, and UV radiation, leading to a higher likelihood of failure over time.

In light of these limitations, there exists a need for an improved supply drop connector system that addresses the issues of durability, ease of reattachment, and adaptability to environmental conditions. Such a system would ideally allow for quick and efficient reconnection of the supply drop to the utility recipient in the event of a disconnection, thereby minimizing downtime and repair costs. The system should also be robust enough to withstand environmental stressors and physical disruptions, ensuring a more reliable and long-lasting power supply connection.

### SUMMARY OF THE INVENTION

The present invention provides a breakaway connector that is operably incorporated into a service drop line, enhancing the safety and reliability of electricity transmission from utility infrastructure to end-user structures. The breakaway connector, innovatively integrated within the utility service infrastructure, may be configured to secure overhead high and low-voltage service drop power lines, thereby transmitting electricity efficiently while mitigating potential damage to utility and end-user assets.

The breakaway connector may include a male connector half and a female connector half, each seamlessly integrated into the service drop power line. These halves include multiple conductive cables and are designed to ensure a robust and secure electrical connection. The male connector half features a proximal end connected to the supply drop lines and a distal end with multiple electrical receptacles arranged to mate with corresponding pins within the female connector half. These connector halves may ensure electrical continuity and incorporate helical channels with receivers to engage with fasteners from the female housing, securing the connection. The fasteners may include a predetermined failure point that is operable to shear at a predetermined location.

To allow controlled failure under specific conditions, the design of breakaway mechanisms for the connector fasteners must balance mechanical reliability with intentional structural weakness when a particular minimum tensile force is applied to the service drop power lines. In some embodiments, a shear pin mechanism may be used as the controlled failure mechanism, where pins are engineered to fail at predetermined load thresholds. The shear pins may comprise aluminum, composite alloys, or other appropriate materials, with precise dimensional configurations, such as reduced cross-sectional areas at shear zones, to ensure predictable disconnection. The shear pins may be notched or scored, where intentional weaknesses, such as grooves or notches, are introduced at specific locations to concentrate stress and guide failure at predetermined points. In other embodiments, frangible bolts fabricated from materials such as ceramics or low-strength alloys may be used and may fracture when subjected to a minimum threshold load.

In other embodiments, the breakaway mechanism may include composite material fasteners with multi-layer designs that incorporate an inner core engineered to fail under specific loads while outer layers offer environmental protection and structural stability. To address environmental factors, fasteners can incorporate protective coatings or be constructed from corrosion-resistant alloys such as anodized aluminum or stainless steel. Additionally, using materials with low thermal expansion can help maintain consistent performance across varying temperature ranges.

The present invention may include insulated regions extending beyond electrical receptacles and contacts to prevent external electrical continuity, alignment features to avoid improper connections, and varied sizes of receptacles and contacts for specific cables to prevent misalignment. In some embodiments, the housings of both connector halves may include interior tapered surfaces to facilitate correct positioning and secure assembly while allowing free rotation to prevent undue torque on the service drop lines. In some embodiments, the connector halves may be configured to permit relative rotation between the housing and conductive elements.

In some embodiments, the breakaway connector may omit the helical channel configuration and instead employ a non-helical retention mechanism configured to secure the male and female connector halves while still permitting controlled separation under externally applied mechanical loads. In such embodiments, retention may be achieved using one or more sacrificial fasteners oriented radially, axially, or circumferentially relative to the connector housings. For example, the male housing may include one or more axial receivers configured to receive radially inserted shear pins or frangible fasteners extending through corresponding through-bores formed in the female housing. The sacrificial fasteners may be configured to engage the receivers without requiring relative rotation between the connector halves during assembly.

In other embodiments, the non-helical retention mechanism may include bayonet-style engagement features, partial-rotation locking elements, external clamp structures, or circumferential retention rings, each incorporating one or more sacrificial elements configured to fail at a predetermined tensile or shear load. The sacrificial elements may be positioned such that failure results in axial separation of the connector halves without deformation of the electrical contacts or conductive terminations. These alternative retention configurations may provide simplified assembly, reduced rotational requirements during installation, or compatibility with specific utility installation practices, while maintaining the controlled breakaway functionality described herein.

In some embodiments, each conductive cable of the service drop line is mechanically and electrically secured to a corresponding conductive contact, pin, or sleeve within the connector halves using a termination mechanism selected from compression crimps, wedge-type clamps, bolted compression fittings, or combinations thereof. The termination mechanism may be configured to establish a permanent electrical connection that is mechanically independent from the sacrificial fasteners and breakaway retention mechanism. In this manner, tensile or shear forces applied to the connector housing during a breakaway event are not transmitted directly to the electrical terminations.

In some embodiments, the breakaway connector defines a primary mechanical load path extending between the service drop conductors and the connector housings, wherein externally applied tensile, shear, or torsional forces acting on the service drop power lines are transmitted through structural portions of the connector housings and into one or more sacrificial fasteners. The sacrificial fasteners form an intentional mechanical weak link within the load path and are selected, dimensioned, and positioned such that they experience concentrated mechanical stress relative to other structural elements of the connector.

The electrical contacts, conductive terminations, and insulating regions are mechanically isolated from the primary load path such that externally applied mechanical forces are not directly transferred to the electrical interfaces. In this manner, the sacrificial fasteners are operable as mechanical fuse elements that preferentially fail before deformation, pull-out, or fracture of the conductors, electrical contacts, or insulating components occurs. This hierarchy of mechanical strength ensures predictable separation at a predetermined location while preserving electrical integrity of the connector halves.

In some embodiments, the connector housings, strain-relief systems, and conductive terminations are collectively rated to withstand mechanical loads exceeding the failure threshold of the sacrificial fasteners. Upon failure of the sacrificial fasteners, the connector halves separate along an axial direction without damage to the electrical contacts, thereby enabling post-event inspection, replacement of the sacrificial fasteners, and reassembly without replacement of the electrical terminations.

In some embodiments, the conductive terminations may be encapsulated, potted, or otherwise insulated within the connector housing using polymeric insulating materials to enhance resistance to moisture ingress, environmental degradation, and electrical tracking. The conductive terminations may be configured such that, upon separation of the connector halves due to failure of the sacrificial fasteners, the conductive elements remain shielded from external exposure and are not subject to arcing caused by housing fracture or fastener failure. This structural separation between electrical termination integrity and mechanical breakaway functionality improves reliability under abnormal loading conditions and facilitates safe post-event inspection and repair.

In some embodiments, the breakaway connector may be evaluated using one or more mechanical, environmental, and electrical performance tests selected to assess durability, insulation integrity, conductor retention, and resistance to environmental stressors. Such testing may include, by way of example and without limitation, evaluations relating to tensile loading, impact resistance, moisture exposure, temperature variation, insulation resistance, and mechanical retention of conductors. These evaluations may be selected to reflect conditions encountered in utility service drop installations, including abnormal loading events resulting from external mechanical forces.

The breakaway connector described herein is not intended to function as a switching device, disconnecting means, or current-interrupting apparatus, and is not operable to intentionally make or break electrical current in response to electrical conditions. The connector is configured to separate solely as a result of externally applied mechanical forces exceeding a predetermined threshold, without regard to the energized or de-energized state of the conductors. As such, testing or evaluation methods applicable to intentional current interruption, switching endurance, or controlled electrical disconnection are not required for operation of the breakaway connector and are not determinative of its functionality.

In some embodiments, performance evaluation criteria may be derived from existing connector testing practices, utility installation requirements, or custom test protocols developed to assess mechanically actuated separation of service drop connectors. Such evaluation criteria are illustrative and non-limiting, and the invention is not restricted to compliance with any particular testing methodology or industry standard. Future testing protocols or standards developed specifically for mechanically actuated breakaway electrical connectors may likewise be applied without departing from the scope of the invention.

Further enhancing the utility and safety of the system, the conductive cables may be attached to the connector halves using a wedge and a cable supporting system, such as a Kellum grip, P-Clip, or cable lacing, to alleviate strain on the connections. Kellum grips, P-Clips, and cable lacing may be used to manage cable strain. Their integration into the described breakaway connector system may enhance durability and reliability by mitigating strain on conductive cables. Kellum grips distribute tension evenly across the cable length by encasing it in a woven mesh of steel or synthetic material. In some embodiments, Kellum grips can be installed in the breakaway connector system at points where the cables exit the connector housing. These grips would anchor the cables to the utility pole or another fixed structure, transferring tensile forces away from the electrical contacts within the connector. This prevents stress-induced deformation or dislodgment of internal components during extreme conditions, such as high winds or accidental impacts.

In some embodiments, may be used to affix cables to the exterior housing of the connector or nearby infrastructure. P-Clips provide localized strain relief by clamping the cables securely to structural elements. By securing cables firmly in place, P-Clips may prevent excessive movement that could otherwise strain the connections.

In some embodiments, cable lacing, involving tightly bound cords or tapes, can bundle and stabilize multiple cables exiting the connector. This may prevent individual cables from pulling unevenly or shifting independently, maintaining alignment and reducing torsional forces on the connector halves.

Additionally, the connector halves may incorporate a biasing mechanism to maintain engagement with the fastener and helical channel during assembly. Importantly, the fasteners are designed to be sacrificial, shearing under predetermined loads to prevent infrastructure damage, with the option of a protective sleeve in the receiver to safeguard the male half.

The biasing mechanisms may maintain secure engagement between fasteners and helical channels, ensuring reliable operation while allowing controlled disengagement under specific conditions. Spring-based mechanisms using a compression spring positioned within the housing to exert continuous pressure on the fastener, pushing it into the receiver located along the helical channel. This approach provides a predictable and consistent force, with the spring often enclosed in a protective casing to prevent environmental degradation such as rust or fatigue. Magnetic biasing is another effective option, where permanent magnets embedded in the fastener or housing generate a magnetic force to hold the fastener in place. This method minimizes wear and tear due to the absence of moving parts, and materials like neodymium are often used for their strong holding capabilities and resistance to demagnetization. Elastic or rubber-based components, such as gaskets or rings, can also serve as biasing mechanisms by applying tension that maintains engagement and absorbing vibrations or minor movements that might otherwise cause disengagement.

It is another aspect of the present invention to provide a breakaway connector for service drop power lines that may include a male connector half configured to couple with a utility-side service drop line, the male connector half including a proximal end with a plurality of electrical receptacles (e.g., sleeves, sockets, or conductive barrels) and an insulated region, and a female connector half configured to couple with an end-user-side service drop line, the female connector half including a proximal end with a plurality of electrical contacts (e.g., pins, blades, or conductive posts) and an insulated region. The breakaway connector may further include helical channels formed on the male connector half and corresponding receivers that may be configured to engage fasteners extending from the female connector half, fasteners having predetermined failure points operable to shear under a specified load to prevent damage to connected infrastructure, and alignment features that may be configured to ensure proper orientation and connection of the male and female connector halves.

It is a further aspect of the present invention to provide the breakaway connector such that the fasteners may include shear pins having a reduced cross-sectional area defining a shear zone, the fasteners may be formed from anodized aluminum or other corrosion-resistant materials, and protective sleeves may be positioned within the receivers to safeguard the male connector half during fastener failure. The insulated regions may extend beyond the electrical receptacles and electrical contacts to prevent external electrical continuity after separation. The helical channels may include tapered surfaces to facilitate alignment during assembly. The breakaway connector may further include a biasing mechanism positioned within a housing of the male connector half to maintain engagement between the fasteners and the helical channels, the biasing mechanism including a spring-based system, a magnetic system, or combinations thereof. The breakaway connector may further include a cable strain relief element such as a Kellum grip (e.g., woven mesh grip), and the alignment features may prevent misalignment by varying sizes of the electrical receptacles and electrical contacts.

It is an aspect of the present invention to provide a high-voltage breakaway connector system for utility infrastructure that may include a male housing and a female housing, each housing including alignment features that ensure proper mating of conductive elements, conductive cables coupled to the housings using a wedge-type termination and a strain relief mechanism, fasteners formed from composite materials and having predetermined failure points, and biasing mechanisms that may be configured to maintain engagement during normal operation and allow controlled disengagement under stress.

It is a further aspect of the present invention to provide the high-voltage breakaway connector system such that the biasing mechanisms may include rubber-based components, magnetic elements, or combinations thereof, and the composite materials may include a multi-layer structure having an inner core engineered to fail under specific mechanical loads. The alignment features may include keyed slots, insulated regions may extend beyond conductive contacts, and the fasteners may be coated with corrosion-resistant materials. The housings may be fabricated from stainless steel or other durable materials and may include environmental sealing gaskets. The strain relief mechanism may include P-Clips, and the biasing mechanisms may absorb vibration to maintain engagement of the connector components.

It is another aspect of the present invention to provide a breakaway connector for electrical service infrastructure that may include a male housing having helical channels and a receiver engaged with a sacrificial fastener, a female housing having through-holes that receive the sacrificial fastener, insulated regions designed to prevent external electrical continuity, and a quick-release mechanism that permits rapid replacement of connector halves after disconnection.

It is a further aspect of the present invention to provide the breakaway connector such that a quick-release mechanism may include spring-loaded fasteners, magnetic coupling elements, or combinations thereof, and the sacrificial fasteners may be designed for single-use replacement. The insulated regions may include UV-resistant coatings, the housings may resist thermal expansion, and the fasteners may include integrated notches that guide failure. The breakaway connector may further include strain-relief mechanisms positioned at cable exits, housings constructed from polymeric materials, and a quick-release mechanism operable with standard lineman tools. The fasteners may further include breakaway bolts configured to fail at specified mechanical thresholds.

It is an aspect of the present invention to provide a breakaway connector for service drop power lines that may include a first connector half coupled to a first portion of a service drop power line, the first connector half having a housing and a plurality of electrical contacts or receptacles electrically connected to one or more conductors, and a second connector half coupled to a second portion of the service drop power line, the second connector half having a housing and a plurality of mating electrical contacts or receptacles electrically connected to one or more conductors. The breakaway connector may further include at least one receiver formed in the housing of one of the first connector half or the second connector half, at least one sacrificial fastener extending through the housing of the other connector half and engaged with the receiver to mechanically retain the connector halves in an assembled state, and a failure region formed in the sacrificial fastener that shears or fractures when an externally applied mechanical force on the service drop power line exceeds a predetermined threshold, thereby permitting separation of the connector halves without intentional interruption of electrical current.

It is a further aspect of the present invention to provide the breakaway connector such that the sacrificial fastener may include a plurality of fasteners circumferentially spaced about the housing, each sacrificial fastener including a corresponding receiver, and separation occurs only after shearing of the plurality of fasteners. The electrical contacts or receptacles may be mechanically secured to the conductors by compression or wedge-type terminations that are structurally independent from the sacrificial fasteners and receivers. Insulated regions may extend beyond the electrical contacts or receptacles such that, after separation of the connector halves, the electrical contacts or receptacles remain shielded from external exposure.

Further aspects and embodiments will be apparent to those having skill in the art from the description and disclosure provided herein.

It is an object of the present invention to provide a breakaway connector that is operable to fail at a predetermined location and provide lineman with a rapid method of replacing the fastener and connecting the supply drop powerline connectors in the event of downed line.

It is an object of the present invention to provide a breakaway connector that is operable to separate while energized as a result of externally applied mechanical forces or loading and is not intended to intentionally interrupt electrical current and is not operable as a switching or disconnecting device.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides an exemplary environmental view of a breakaway connector incorporated into the infrastructure of a utility servicer, according to an embodiment of the present invention.

FIG. 2 provides an exemplary exploded view of a breakaway connector, according to an embodiment of the present invention.

FIG. 3 provides an exemplary side view of a breakaway connector, according to an embodiment of the present invention.

FIG. 4 provides a sectioned view of a breakaway connector about the line B-B of FIG. 3, according to an embodiment of the present invention.

FIG. 5 provides a proximal view of a breakaway connector, according to an embodiment of the present invention.

FIG. 6 provides a sectioned view of a breakaway connector about line A-A of FIG. 5, according to an embodiment of the present invention.

FIG. 7 provides an exemplary exploded side view of a breakaway connector, according to an embodiment of the present invention.

FIG. 8 provides a sectioned view of a breakaway connector about the line C-C of FIG. 7, according to an embodiment of the present invention.

FIG. 9 provides a perspective view of a breakaway connector, according to an embodiment of the present invention.

FIG. 10 provides an exemplary exploded side view of a breakaway connector, according to an embodiment of the present invention.

FIG. 11 provides a sectioned view of a breakaway connector about the line D-D of FIG. 10, according to an embodiment of the present invention.

The drawings are not at scale and present a simplified representation of various features illustrative of the basic principles of the invention. Certain invention features such as dimension, orientation, location, shape and material will be determined by application, size and shape.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

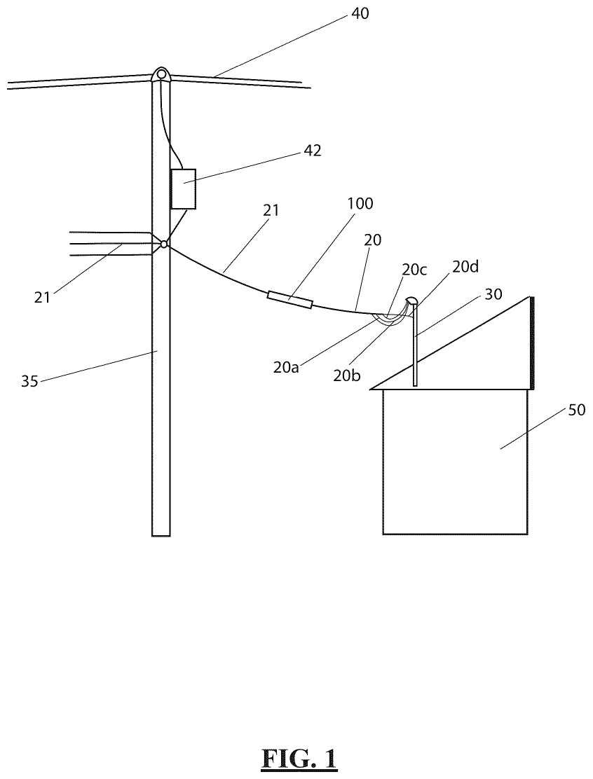

The present invention concerns a breakaway connector operably incorporated into a service drop line. FIG. 1 provides an environmental view of the breakaway connector 100 incorporated into the infrastructure of a utility servicer according to the present invention. A utility pole 35 may secure overhead high voltage (e.g., primary) power lines 40 and low voltage service drop power lines 21,20 that are operable to transmit electricity from the utility infrastructure to the end-user structure 50. The service drop power lines may have a utility side 21 and an end-user side 20. The high voltage power lines 40 and the supply drop power lines 21,20 may be coupled to a transform 42 that is operable to step up or down the voltage prior to transmitting electricity to the end user structure 50. The breakaway connector 100 may be coupled along the length of the service drop power lines 21,20. The end-user structure 50 may include a service entrance point 30 (e.g., riser pipe) that is operable to receive the individual cables within the service drop power line 20.

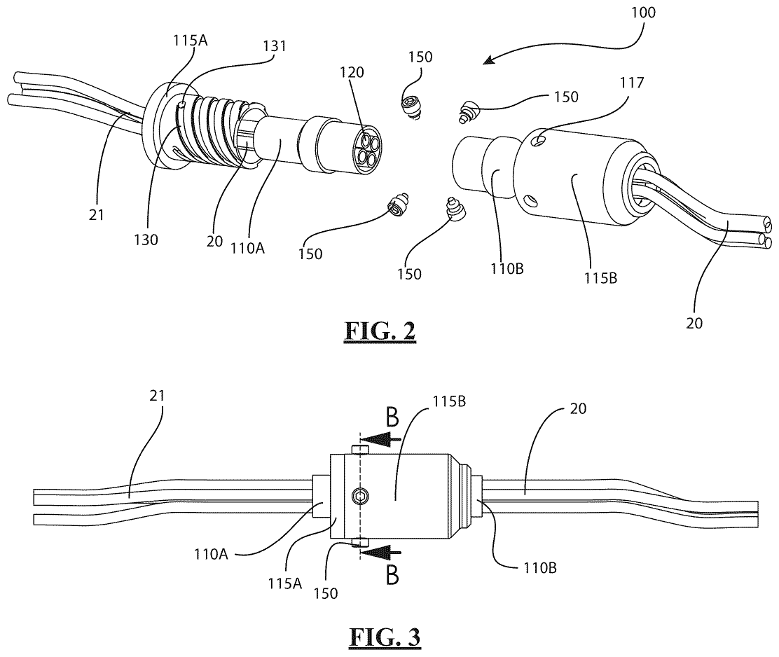

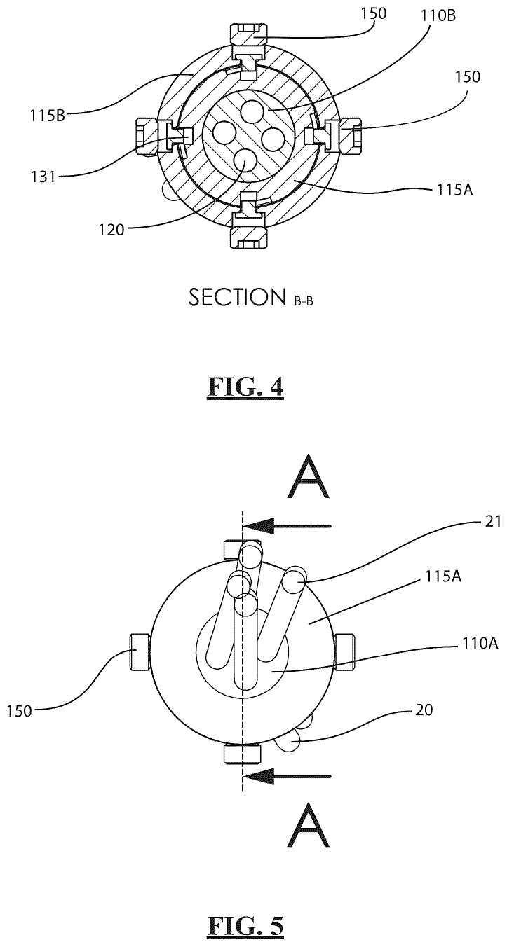

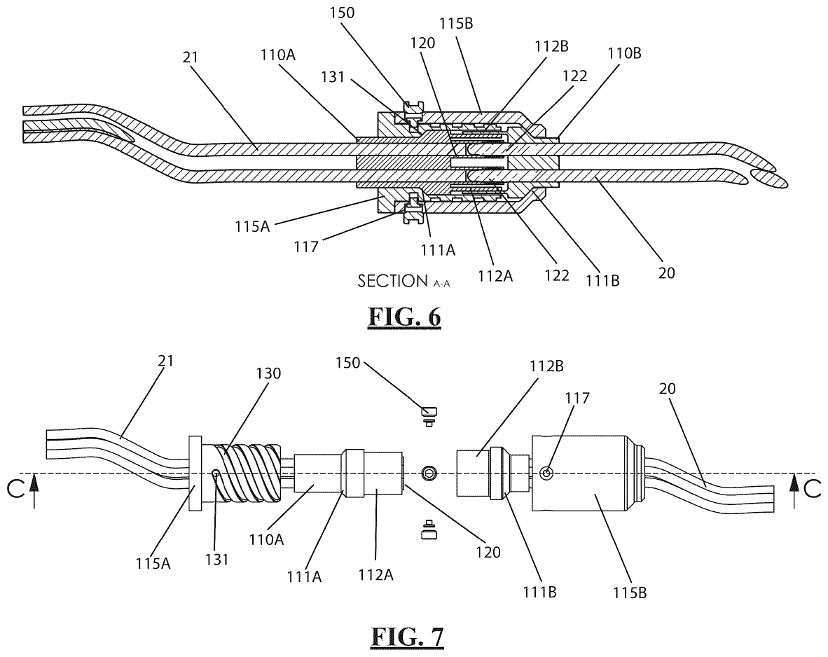

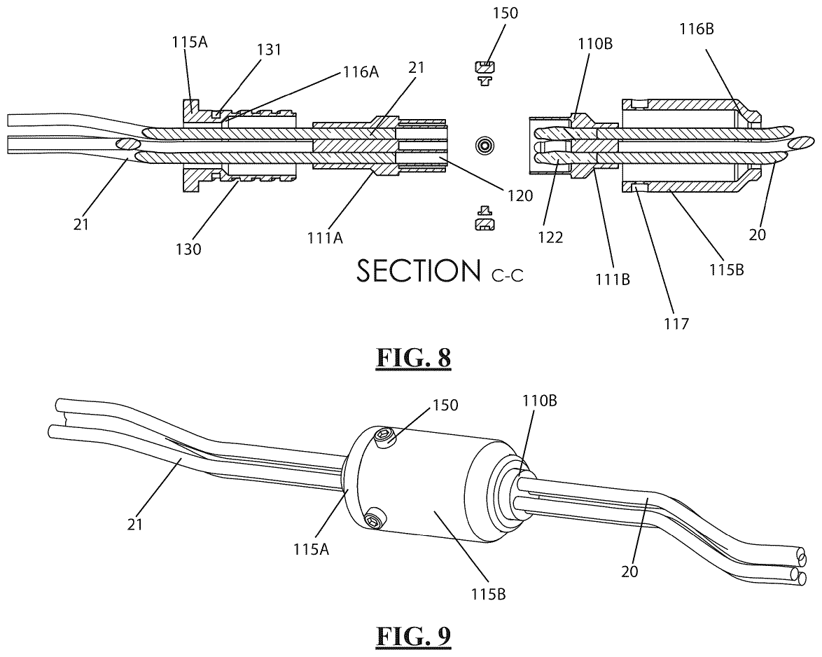

The exemplary breakaway connector of the present invention may include a male connector half 110A and a female connector half 110B, each being operably integrated into a service drop power line 20,21 consisting of multiple conductive cables (20a, 20b, 20c). The male connector half 110A may be coupled to the utility side of the supply drop power line 21, and the female connector half 110B may be coupled to the end-user side of the supply drop line 20. As illustrated in FIG. 2, the male connector half 110A may include a proximal end coupled to the supply drop lines 20 and a distal end with a plurality of electrical receptacles 120 (e.g., sleeves). The electrical receptacles 120 are arranged to mate with corresponding receptacles (e.g., pins) within the female connector half 110B, ensuring electrical continuity when the connector halves are engaged. The male connector half 110A may include a male housing 115A having a plurality of helical channels 130 on the exterior surface. Each helical channel 130 may include a receiver 131 positioned at the end of the helical channel path and is operable to receive a fastener 150 of the female housing 110B. The female connector half 115B may include a female housing 110B having a plurality of through-holes 117 that are concentrically and equidistantly distributed around the female housing and are operable to receive a fastener 150. The fastener 150 may engage with the receiver 131 of the male housing 115, securing the first and second halves (115A, 115B). In some embodiments, the exterior housing (110A, 110B) may include alignment features that may be keyed or otherwise configured to prevent improper connection and ensure proper orientation and connection of the contacts 130.

In some embodiments, the male half 115A may include an insulated region 112A extending beyond the electrical receptacle 120, thereby preventing electrical continuity with the external environment. Similarly, the female half 115B may include an insulated region 112B that extends beyond the electrical contacts 122, thereby preventing electrical continuity with the external environment. In some embodiments, the electrical receptacles 120 and the electrical contacts 122 may include an alignment feature that is operable to prevent improper connection. In such embodiments, the electrical receptacles and contacts (120, 122) may have various sizes, each corresponding to a specific cable in the power supply drop line 20, 21, thereby preventing misalignment. In some embodiments, the insulated regions may be keyed or otherwise configured to prevent improper connection.

In some embodiments, the male housings 115A may include an interior surface with a tapered surface 116A that is operable to position and align a wedged exterior surface 111A of the male connector half 110A when assembling the male connector half 110A into the male housing 115A. Similarly, the female housings 115B may include an interior surface with a tapered surface 116B that is operable to position and secure a wedged exterior surface 111B of the female connector half 110B when assembling the female connector half 110B into the male housing 115B. In such embodiments, the male end housing 115A and female housing 115B may be operable to rotate freely without imparting any force onto the first half and second half 110A, 110B, thereby preventing additional torque on the service drop power line 20,21 during assembly of the breakaway connector 100.

In some embodiments, the conductive cables 20, 21 may be coupled to the male and female halves (115A, 115B) using a wedge and may include a cable supporting system that is operable to relieve strain on the electrical cable connection. In such embodiments, cable supporting systems may include a Kellum grip, P-Clip, or cable lacing that are operable to prevent strain on supply drop lines 20 and 21 when secured to the breakaway connector.

In some embodiments, the female or male housing (110A, 110B) may include a biasing mechanism that is operable to position and advance the fastener 150 and maintain engagement with the helical channel 130 when assembling the breakaway connector. The biasing mechanism may include a spring, magnet, or other suitable mechanism that is operable to align the fastener 150 with the receiver 131. Each of the fasteners 150 may be sacrificial and may have a region that is operable to shear or fail under a predetermined load, thereby preventing damage to the utility infrastructure (e.g., pole) and the end-user structure 50. Fasteners may include breakaway nuts, breakaway bolts, frangible bolts, fuse pins, and shear bolts or shear pins. In some embodiments, the shear location may be along the interface of the receiver 131 and the interior surface of the female housing 110B. In some embodiments, a sleeve may be positioned in the receiver and is operable to prevent damage to the male half 110A.

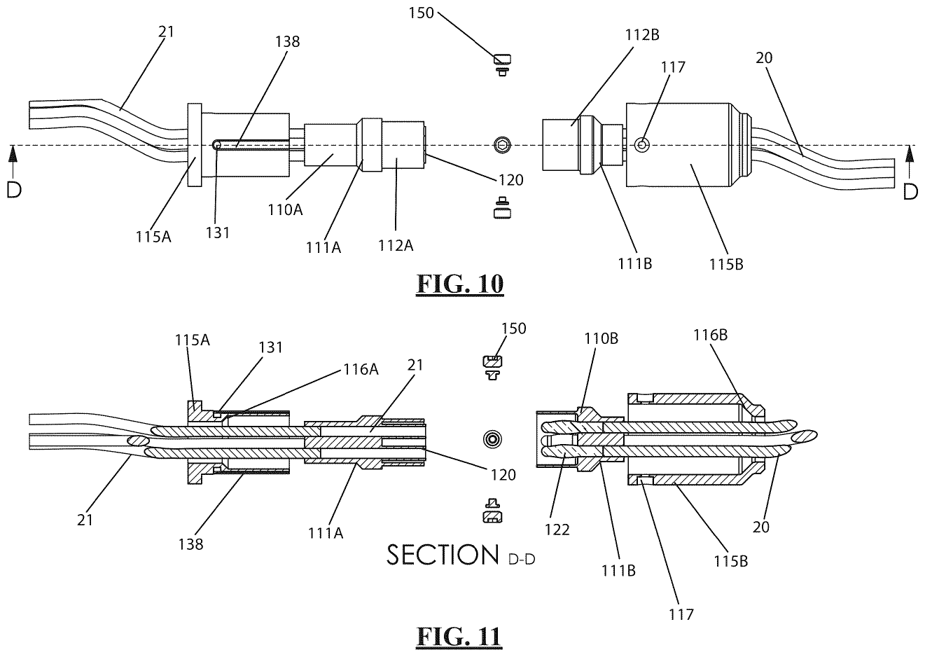

Referring now to FIGS. 10 and 11, it is seen that in some embodiments of the breakaway connector 100, the male connector half 110A and the female connector half 110B are joined along a substantially straight axial engagement path 138. The male connector half 110A includes one or more receivers 131 formed in or coupled to the housing 115A, and the female connector half 110B includes one or more through-holes 117 formed in the housing 115B. One or more sacrificial fasteners 150 extend through the through-holes 117 and engage the corresponding receivers 131 to mechanically retain the connector halves in an assembled state. The sacrificial fasteners 150 include predetermined failure regions selected to shear or fracture when externally applied mechanical forces acting on the service drop power lines 20, 21 exceed a predetermined threshold, thereby permitting axial separation of the connector halves.

In such embodiments, the straight-line breakaway configuration defines a primary mechanical load path extending through the housings 115A, 115B and the sacrificial fasteners 150, while the electrical contacts 120, 122 and associated conductive terminations remain mechanically isolated from the fasteners and receivers. The conductive cables 20, 21 are secured to the electrical contacts by compression, wedge, or similar termination mechanisms positioned within insulated regions 112A, 112B such that tensile or shear forces applied to the service drop lines are preferentially transferred to the sacrificial fasteners rather than to the electrical terminations. Upon failure of the sacrificial fasteners 150, the connector halves separate in a controlled axial manner, with the electrical contacts remaining shielded from external exposure, thereby enabling replacement of the sacrificial fasteners and reassembly of the connector without replacement of the electrical terminations.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

### No Warranties

The preceding detailed description has been prepared to solely comply with the provisions of 35 U.S.C. § 112, and does not constitute a commercial warranty, (either expressed or implied), as to the effectiveness of the apparatus and methods disclosed herein, nor does this disclosure constitute any type of certification or guarantee of any particular outcomes. Therefore, this disclosure may not be relied upon to support any future legal claims including, but not limited to, breach of warranty of merchantability, or fitness for any particular purpose which is directed, in whole, or in part, to the present apparatus or methods.

1. A breakaway connector for service drop power lines, comprising:
a. a male connector half operable to couple with a utility-side service drop line, the male connector half including a proximal end with a plurality of electrical receptacles and an insulated region;
b. a female connector half operable to couple with an end-user-side service drop line, the female connector half including a proximal end with a plurality of electrical contacts and an insulated region;
c. helical channels on the male connector half and receivers configured to engage fasteners from the female connector half; and
d. fasteners with predetermined failure points operable to shear under a specified load to prevent damage to the connected infrastructure.

2. The breakaway connector of claim 1, wherein the fasteners comprise shear pins with a reduced cross-sectional area at a shear zone.

3. The breakaway connector of claim 1, wherein the fasteners are made of anodized aluminum.

4. The breakaway connector of claim 1, further comprising protective sleeves positioned within the receivers to safeguard the male connector half.

5. The breakaway connector of claim 1, wherein the insulated regions extend beyond the electrical receptacles and contacts to prevent external electrical continuity.

6. (canceled)

7. The breakaway connector of claim 1, further comprising a biasing mechanism in the male housing to maintain engagement with the helical channels.

8. (canceled)

9. (canceled)

10. The breakaway connector of claim 1, further comprising a Kellum grip to distribute tension along the cable length.

11. The breakaway connector of claim 1, further comprising alignment features configured to ensure proper orientation and connection of the male and female connector halves, wherein the alignment features prevent misalignment by varying the sizes of the electrical receptacles and contacts.

12. A breakaway connector for electrical service lines, comprising:
a. a male connector half and a female connector half, each configured with housing that permits rotation during assembly without imparting torque to the electrical service lines;
b. sacrificial fasteners integrated into the female housing and configured to engage receivers on the male housing; and
c. a cable strain relief system comprising at least one of a Kellum grip, P-clip, or cable lacing to alleviate stress on the electrical cable connections.

13. The breakaway connector of claim 12, wherein the sacrificial fasteners comprise frangible bolts.

14. The breakaway connector of claim 12, wherein the rotation mechanism comprises tapered surfaces on the male and female housings.

15. (canceled)

16. The breakaway connector of claim 12, further comprising insulated coatings on the housing to resist environmental degradation.

17. The breakaway connector of claim 12, wherein the cable strain relief system includes a Kellum grip installed at the connector housing exit points.

18. The breakaway connector of claim 12, wherein the cable strain relief system includes cable lacing to bundle and stabilize multiple cables.

19. The breakaway connector of claim 12, wherein the sacrificial fasteners include grooves to guide failure at predetermined points.

20. (canceled)

21. (canceled)

22. (canceled)

23. A high-voltage breakaway connector system for utility infrastructure, comprising:
a. a male housing and a female housing, each including alignment features that ensure proper mating of conductive elements;
b. conductive cables coupled to the housings using a wedge and a strain relief mechanism;
c. fasteners with predetermined failure points made of composite materials; and
d. biasing mechanisms configured to maintain engagement during normal operation and allow controlled disengagement under stress.

24. (canceled)

25. The breakaway connector system of claim 23, wherein the composite materials include a multi-layer design with an inner core engineered to fail under specific loads.

26. (canceled)

27. (canceled)

28. The breakaway connector system of claim 23, wherein the fasteners are coated with corrosion-resistant materials.

29. (canceled)

30. (canceled)

31. The breakaway connector system of claim 23, wherein the housings include environmental sealing gaskets.

32. (canceled)

33. The breakaway connector system of claim 23, wherein the biasing mechanisms absorb vibrations to maintain engagement.

34-48. (canceled)
